(19) United States
(12) Patent Application Publication
(10) Pub. No.: US 2026/0210796 A1
(43) Pub. Date: Jul. 23, 2026

(54) CONTROL METHOD FOR SEISMIC SIMULATION SHAKING TABLE UNDER COMBINED LOADING OF SEISMIC WAVES AND CURRENTS

(71) Applicant: Tianjin University, Tianjin (CN)

(72) Inventors: Hao Wu, Tianjin (CN); Ximing Zhu, Tianjin (CN); Qinghua Han, Tianjin (CN); Mingjie Liu, Tianjin (CN); Yan Lu, Tianjin (CN); Xiang Yan, Tianjin (CN)

(21) Appl. No.: 19/385,033

(22) Filed: Nov. 10, 2025

(30) Foreign Application Priority Data
Jan. 23, 2025 (CN) 202510120677.7

(51) Int. Cl. G01M 7/02; G01M 7/06; G01V 20/00

(52) U.S. Cl. CPC G01M 7/022; G01M 7/025; G01M 7/06; G01V 20/00

(57) ABSTRACT

A control method for a seismic simulation shaking table under combined loading of seismic waves and currents includes the steps of: establishing a seismic simulation shaking table system and a control system; and taking a target seismic wave and an actual acceleration signal of a shaking table body as feedback signals, and jointly inputting the two into the control system. The control system includes a disturbance rejection control loop, a proportional-integral-derivative (PID) control loop and an acceleration outer closed loop. In the present disclosure, by designing the PID control loop-the disturbance rejection control loop-the acceleration outer closed loop for the seismic simulation vibration table system, the influence of hydrodynamic forces including waves and currents and internal resonance effects thereof on system accuracy is reduced, and the accurate tracking of seismic wave acceleration signals is achieved.

### CROSS-REFERENCE TO RELATED APPLICATION

This application claims priority of Chinese Patent Application No. 202510120677.7, filed on Jan. 23, 2025, the entire contents of which are incorporated herein by reference.

### TECHNICAL FIELD

The present disclosure relates to the technical field of seismic simulation experiments, and in particular to a control method for a seismic simulation shaking table under combined loading of seismic waves and currents.

### BACKGROUND

Earthquake is a natural disaster with immense destructive potential and high unpredictability. To mitigate economic losses and casualties caused by seismic events, it is crucial to perform rational seismic designs for building structures, ensuring the designs meet comprehensive safety and economic requirements for engineering structures under earthquake-induced actions. Due to the strong uncertainty of earthquake occurrence, it is difficult to perform structural seismic research under actual seismic conditions as required. Seismic simulation shaking table can simulate seismic motions in laboratory environments and test structural reliability, thereby improving the seismic capacity of structure and strengthening the existing structure.

The seismic simulation shaking table generally consists of a controller, actuators, a shaking table body and a building foundation. The controller obtains the actuator command through calculation, drives the actuators, and the actuators drive the shaking table face to move. The seismic simulation shaking table can realize the motion along six-degree-of-freedom (6-DOF) directions: X, Y, Z, Rx, Ry and Rz.

In the existing control methods, due to the hydrodynamic effects produced by the waves and fluids on the shaking table body/test piece, these effects, along with the characteristics of the hydraulic system, the performance of the sensors, and other nonlinear factors, jointly lead to the vibration table system demonstrating obvious nonlinearity and uncertainty, making it difficult to achieve the control effect required for the experiment.

### SUMMARY

An objective of the present disclosure is to provide a control method for a seismic simulation shaking table under combined loading of seismic waves and currents, which reduces the hydrodynamic influence of waves and water currents on a seismic simulation shaking table system and improves the control accuracy of a shaking table body by designing a proportional-integral-derivative (PID) control loop, a disturbance rejection control loop and an acceleration outer closed loop for the seismic simulation shaking table.

To achieve the above objective, the present disclosure provides the following technical solutions.

The present disclosure provides a control method for a seismic simulation shaking table under combined loading of seismic waves and currents, including the following steps:
establishing a seismic simulation shaking table system and a control system; and
taking a target seismic wave as a reference signal, taking an actual acceleration signal of a shaking table body in the seismic simulation shaking table system as a feedback signal, and jointly inputting the two into the control system, in which
the control system includes a disturbance rejection control loop, a PID control loop and an acceleration outer closed loop;
the acceleration outer closed loop is used for comparing the reference signal of the shaking table body with the feedback signal, and obtaining a corrected actual acceleration signal through error correction;
the disturbance rejection control loop is used for compensating and processing the corrected actual acceleration signal and velocity signals and displacement signals of the shaking table body in 6-DOF directions to generate control instructions in the 6-DOF directions; and
the PID control loop is used for converting the control instructions into control signals of each actuator in the seismic simulation shaking table system through a DOF decomposition matrix, thereby driving the shaking table body to move in the 6-DOF directions through each actuator, and feeding back the velocity signals and the displacement signals in the 6-DOF directions of the shaking table body into the disturbance rejection control loop.

Further, the seismic simulation shaking table system includes a building foundation, a shaking table body, a plurality of transverse actuators, and a plurality of vertical actuators;
the building foundation is used for providing a support platform for the shaking table body;
the shaking table body is used for generating a seismic wave motion corresponding to a target seismic wave signal;
the plurality of transverse actuators and the plurality of vertical actuators are used for applying force and displacement to the shaking table body to simulate seismic waves with different intensity and frequency characteristics;
the plurality of transverse actuators and the plurality of vertical actuators are arranged with displacement sensors, and the displacement sensors are used for measuring and feeding back an actual displacement signal of each actuator;
the shaking table body is arranged with an acceleration sensor, which is used for measuring actual acceleration signals in the 6-DOF directions of the shaking table body; and
the shaking table body is movably connected to the building foundation through the plurality of transverse actuators and the plurality of vertical actuators.

Further, a sampling time of the target seismic wave is 0.001 s, and a seismic wave in a frequency band of 0.1-25 Hz is extracted by fast Fourier transform/inverse fast Fourier transform (FFT/IFFT).

Further, a correction strategy of the acceleration outer closed loop is as follows:
an actual acceleration signal of the shaking table body after Kalman filtering is subtracted from twice the target seismic wave signal.

Further, the disturbance rejection control loop includes a disturbance rejection controller;
the disturbance rejection controller includes a notch filter, a signal generator and a state observer;
the notch filter is used for compensating the resonance effect of the shaking table body at a specific frequency to obtain a compensated acceleration signal;
the signal generator is used for processing the compensated acceleration signal to obtain acceleration, velocity and displacement signals, and removing the low-frequency portion to prevent the influence of zero drift; and V_{f} and d_{f} are parameters used in signal processing;
the state observer is used for observing the velocity signals in the 6-DOF directions of the shaking table body and the total disturbance of the seismic simulation shaking table system to obtain a velocity observation value and a total disturbance observation value output by the seismic simulation shaking table system; and
the disturbance rejection controller is used for designing a state error feedback control law by combining the acceleration, velocity and displacement signals obtained by the signal generator with the velocity observation value, the displacement signals in the 6-DOF directions of the shaking table body, and the total disturbance observation value.

Further, a method for constructing the state observer includes the steps of:
for any DOF of the shaking table body, the seismic simulation shaking table system is described as a system including a total disturbance term, and an expanded state space equation of the seismic simulation shaking table system is as follows:

$$[ \begin{matrix}{\dot{x}}_{1} \\ {\dot{x}}_{2}\end{matrix} ] = [ \begin{matrix}0 & 1 \\ 0 & 0\end{matrix} ] [ \begin{matrix}{x}_{1} \\ {x}_{2}\end{matrix} ] + [ \begin{matrix}{b}_{0} \\ 0\end{matrix} ] u + [ \begin{matrix}0 \\ 1\end{matrix} ] {\dot{x}}_{2}$$

$$y = [ \begin{matrix}1 & 0\end{matrix} ] [ \begin{matrix}{x}_{1} \\ {x}_{2}\end{matrix} ]$$

where u is an input velocity of the seismic simulation shaking table system under this DOF; x₁ is a velocity of the shaking table body at this DOF; \dot{x}₁ is a derivative of the velocity x₁ of the shaking table body at this DOF; x₂ is a total disturbance of the seismic simulation shaking table system; \dot{x}₂ is a derivative of the total disturbance x₂ of the seismic simulation shaking table system; y is an output velocity of the seismic simulation shaking table system; and b₀ represents a characteristic of a control object;
the state observer is constructed by using the expanded state space equation to obtain observed values of the velocity x₁ and total disturbance x₂ of the shaking table body, and an equation expression of the state observer is as follows:

$$[ \begin{matrix}{\dot{z}}_{1} \\ {\dot{z}}_{2}\end{matrix} ] = [ \begin{matrix}- {β}_{1} & 1 \\ - {β}_{2} & 0\end{matrix} ] [ \begin{matrix}{z}_{1} \\ {z}_{2}\end{matrix} ] + [ \begin{matrix}{b}_{0} \\ 0\end{matrix} ] u + [ \begin{matrix}{β}_{1} \\ {β}_{2}\end{matrix} ] y$$

$$\hat{y} = [ \begin{matrix}1 & 0\end{matrix} ] [ \begin{matrix}{z}_{1} \\ {z}_{2}\end{matrix} ]$$

where z₁ is an observed value of velocity x₁; ż₁ is a derivative of the observed value z₁ of the velocity x₁; z₂ is an observed value of the total disturbance x₂; ż₂ is a derivative of the observed value z₂ of the total disturbance x₂; ŷ is an observed value of an output velocity of the seismic simulation shaking table system; and β₁ and β₂ are gains of the state observer.

Further, an expression of the state error feedback control law is as follows:

$$u = \frac{{k}_{p} ( r - {z}_{1} ) + {k}_{i} ( r \frac{1}{2} - {d}_{1} ) + {k}_{d} rs - {z}_{2}}{{b}_{0}}$$

where kₚ, kᵢ and k_{d} are gains of the velocity signal, the displacement signal and the acceleration, r is a velocity signal output by the signal generator, d₁ is displacement signals in the 6-DOF directions of the shaking table body, z₁ is the observed value of the velocity x₁, z₂ is the observed value of the total disturbance x₂, b₀ represents the characteristic of the control object, and s is a complex variable that transforms a time domain function into a complex frequency domain through Laplace transformation;

by bringing the state error feedback control law into a first-order system expression, a closed-loop transfer function of the disturbance rejection controller is obtained:

$$\frac{y ( s )}{r ( s )} = \frac{{k}_{d} {s}^{2} + {k}_{p} s + {k}_{i}}{{s}^{2} + {k}_{p} s + {k}_{i}}$$

where kₚ, kᵢ and k_{d} are the gains of the velocity signal, the displacement signal, and the acceleration.

Further, a transfer function of the notch filter is as follows:

$$N ( s ) = \frac{{s}^{2} + 2 * g * c * w * s + {w}^{2}}{{s}^{2} + 2 * c * w * s + {w}^{2}}$$

where W is a notch frequency in rad/s, g is a notch gain, and C is a damping ratio.

Further, the total perturbation includes an external perturbation and an internal perturbation;
the external disturbance includes the coupling effect of waves and water currents, and the resonance effect among a test piece, each actuator and the shaking table body; and
the internal disturbance includes a modeling error and an unmodeled portion of the seismic simulation shaking table system.

Further, the velocity signals and the displacement signals in the 6-DOF directions of the shaking table body are fed back into the disturbance rejection control loop, and the velocity signals in the 6-DOF directions of the shaking table body are specifically as follows:
obtaining the actual acceleration signals in the 6-DOF directions of the shaking table body by using the acceleration sensor, performing Kalman filtering, and obtaining the velocity signals in the 6-DOF directions of the shaking table body by the velocity synthesis method;
the obtaining the velocity signals in the 6-DOF directions of the shaking table body by the velocity synthesis method specifically includes the steps of:

performing low-pass filtering on the actual displacement signal of each actuator, and obtaining the displacement signals in the 6-DOF directions of the shaking table body by using the DOF synthesis matrix; and
differentiating and low-pass filtering the displacement signals in the 6-DOF directions of the shaking table body, integrating and high-pass filtering the actual acceleration signals in the 6-DOF directions of the shaking table body, and low-pass filtering after summing the two to obtain the velocity signals in the 6-DOF directions of the shaking table body.

According to the specific examples provided by the present disclosure, the present disclosure has the following technical effects.

In the present disclosure, the influence of nonlinear factors on the control accuracy of the seismic simulation shaking table system under combined loading of seismic waves and water currents (such as hydrodynamic effects of waves and water currents and coupling effects thereof, internal resonance, dead zone effects of servo valves, friction and flow nonlinearity, etc.) is effectively reduced, and the acceleration signals of seismic waves are accurately tracked. At the same time, the method in the present disclosure does not depend on the accurate model of the controlled object, has low sensitivity to parameters of the mathematical model, convenient parameter adjustment and good disturbance rejection ability.

### BRIEF DESCRIPTION OF THE DRAWINGS

To explain the examples of the present disclosure or the technical solutions in the prior art more clearly, a brief description will be given below with reference to the accompanying drawings which are used in the description of the examples or the prior art. Obviously, the drawings in the following description are only some examples of the present disclosure, and other drawings can be obtained according to these drawings supplies without creative work for those ordinary skilled in the art.

Hereinafter, a control method for a seismic simulation shaking table under combined loading of seismic waves and currents according to the present disclosure is further described with reference to the accompanying drawings.

FIG. 1 is a schematic structural diagram of a control method for a seismic simulation shaking table under combined loading of seismic waves and currents provided by the present disclosure;

FIG. 2 is a control flow chart of the control method for a seismic simulation shaking table under combined loading of seismic waves and currents provided by the present disclosure;

FIG. 3 is a structural diagram of the control method for a seismic simulation shaking table under combined loading of seismic waves and currents provided by the present disclosure; and

FIG. 4 is a structural diagram of a velocity synthesis method in the control method for a seismic simulation shaking table under combined loading of seismic waves and currents provided by the present disclosure.

Reference numerals and denotations thereof: 1—shaking table body; 2—transverse actuator; 3—vertical actuator; 4—acceleration sensor; and 5—building foundation.

### DETAILED DESCRIPTION

Specific embodiments of the present disclosure are described in further detail below with reference to the accompanying drawings and examples. The following examples are intended to illustrate the present disclosure, but are not intended to limit the scope of the present disclosure.

To better understand the objective, structure and function of the present disclosure, the present disclosure will be described in further detail below with reference to the accompanying drawings.

The present disclosure provides a control method for a seismic simulation shaking table under combined loading of seismic wave and flow, including the following steps.

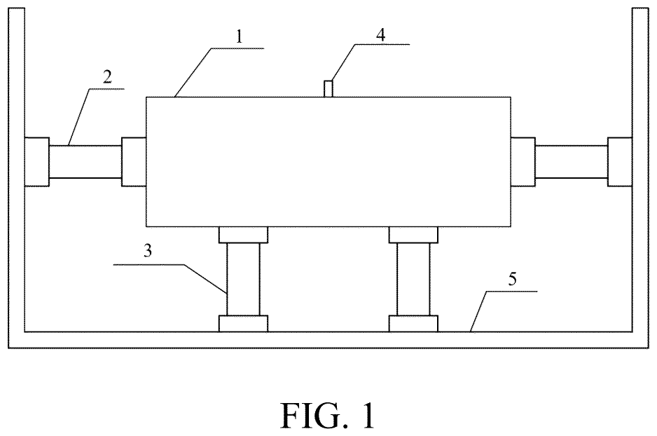

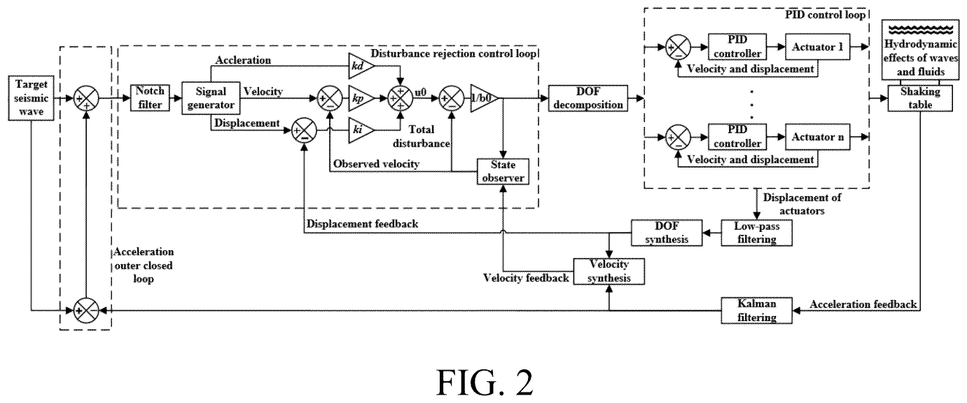

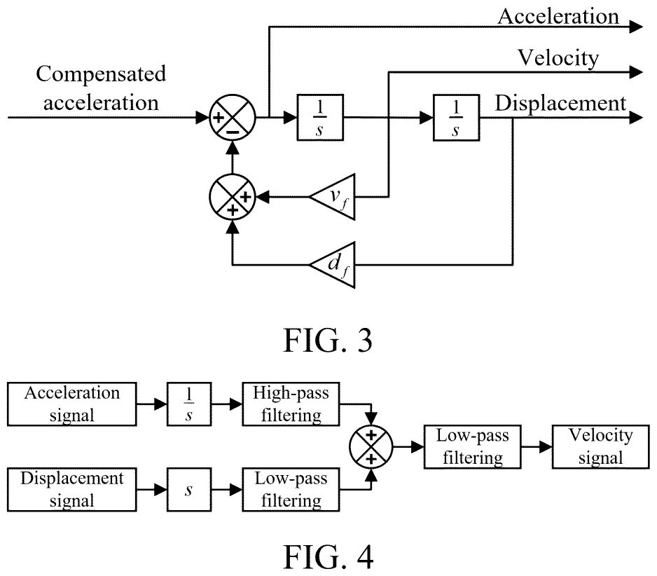

As shown in FIG. 1 and FIG. 2, a seismic simulation shaking table system and a control system are established.

A target seismic wave is taken as a reference signal, and an actual acceleration signal of a shaking table body in the seismic simulation shaking table system is taken as a feedback signal, which are jointly input into the control system.

The control system includes a disturbance rejection control loop, a PID control loop and an acceleration outer closed loop.

The acceleration outer closed loop is used for comparing the reference signal of the shaking table body with the feedback signal, and obtaining a corrected actual acceleration signal through error correction.

The disturbance rejection control loop is used for compensating and processing the corrected actual acceleration signal and velocity signals and displacement signals of the shaking table body in 6-DOF directions to generate control instructions in the 6-DOF directions.

The PID control loop is used for converting the control instructions into control signals of each actuator in the seismic simulation shaking table system through a DOF decomposition matrix, thereby driving the shaking table body to move in the 6-DOF directions through each actuator, and feeding back the velocity signals and the displacement signals in the 6-DOF directions of the shaking table body into the disturbance rejection control loop.

It is to be noted that the PID control loop designs PID feedback by measuring a velocity/displacement signal of each actuator, and controls each actuator to make linear motion according to the control signal.

As shown in FIG. 1, the seismic simulation shaking table system includes a building foundation 5, a shaking table body 1, a plurality of transverse actuators 2, and a plurality of vertical actuators 3.

The building foundation 5 is used for providing a support platform for the shaking table body 1.

The shaking table body 1 is used for generating a seismic wave motion corresponding to a target seismic wave signal.

The plurality of transverse actuators 2 and the plurality of vertical actuators 3 are used for applying force and displacement to the shaking table body 1 to simulate seismic waves with different intensity and frequency characteristics.

The plurality of transverse actuators 2 and the plurality of vertical actuators 3 are arranged with displacement sensors, and the displacement sensors are used for measuring and feeding back an actual displacement signal of each actuator.

The shaking table body 1 is arranged with an acceleration sensor 4, which is used for measuring actual acceleration signals in the 6-DOF directions of the shaking table body 1.

The shaking table body 1 is movably connected to the building foundation 5 through the plurality of transverse actuators 2 and the plurality of vertical actuators 3.

A sampling time of the target seismic wave is 0.001 s, a seismic wave in a frequency band of 0.1-25 Hz is extracted by FFT/IFFT, and a peak value of the seismic wave is set.

In this example, a low-frequency portion below 0.1 Hz is removed to prevent zero drift.

A correction strategy of the acceleration outer closed loop is as follows.

An actual acceleration signal of the shaking table body 1 after Kalman filtering is subtracted from twice the target seismic wave signal.

The disturbance rejection control loop is specifically a disturbance rejection controller.

The disturbance rejection controller includes a notch filter, a signal generator and a state observer.

The notch filter is used for compensating the resonance effect of the shaking table body 1 at a specific frequency to obtain a compensated acceleration signal.

The signal generator is used for processing the compensated acceleration signal to obtain acceleration, velocity and displacement signals, and removing the low-frequency portion to prevent the influence of zero drift.

The state observer is used for observing the velocity signals in the 6-DOF directions of the shaking table body 1 and the total disturbance of the seismic simulation shaking table system to obtain a velocity observation value and a total disturbance observation value output by the seismic simulation shaking table system.

The disturbance rejection controller is used for designing a state error feedback control law by combining the acceleration, velocity and displacement signals obtained by the signal generator with the velocity observation value, the displacement signals in the 6-DOF directions of the shaking table body 1, and the total disturbance observation value.

It is to be noted that the output of the disturbance rejection controller is processed by the DOF decomposition matrix to obtain an input signal of each actuator, and after low-pass filtering is applied to the displacement signal of each actuator, displacements of the shaking table body 1 in 6-DOF directions are obtained using a DOF synthesis matrix. Furthermore, accelerations of the shaking table body 1 in 6-DOF directions are acquired by the acceleration sensor 4, and the acceleration signals are processed with Kalman filtering. Velocities of the shaking table body 1 in 6-DOF directions are obtained through a velocity synthesis method, serving as the feedback for the disturbance rejection controller, as shown in FIG. 4. The disturbance rejection controller outputs 6-DOF commands to generate a control signal of each actuator through the DOF decomposition matrix, and controls each actuator to further control the shaking table body 1 to move in the 6-DOF directions.

A method for constructing the state observer includes the following steps.

For any DOF of the shaking table body 1, the seismic simulation shaking table system is described as a system including a total disturbance term, and an expanded state space equation of the seismic simulation shaking table system is as follows.

$$[ \begin{matrix}{\dot{x}}_{1} \\ {\dot{x}}_{2}\end{matrix} ] = [ \begin{matrix}0 & 1 \\ 0 & 0\end{matrix} ] [ \begin{matrix}{x}_{1} \\ {x}_{2}\end{matrix} ] + [ \begin{matrix}{b}_{0} \\ 0\end{matrix} ] u + [ \begin{matrix}0 \\ 1\end{matrix} ] {\dot{x}}_{2}$$

$$y = [ \begin{matrix}1 & 0\end{matrix} ] [ \begin{matrix}{x}_{1} \\ {x}_{2}\end{matrix} ]$$

where u is an input velocity of the seismic simulation shaking table system under this DOF; x₁ is a velocity of the shaking table body at this DOF; \dot{x}₁ is a derivative of the velocity x₁ of the shaking table body at this DOF; x₂ is a total disturbance of the seismic simulation shaking table system; \dot{x}₂ is a derivative of the total disturbance x₂ of the seismic simulation shaking table system; y is an output velocity of the seismic simulation shaking table system; and b₀ represents a characteristic of a control object; and
where b₀ represents gain of the control object or zero gain of transfer function between inputs and outputs of the seismic simulation shaking table system, b₀ is an adjustable parameter, and the larger the value, the more stable it is. As the value decreases, the control accuracy improves, and the value is selected from large to small according to the situation of the seismic simulation shaking table system.

The state observer is constructed by using the expanded state space equation to obtain observed values of the velocity x₁ and total disturbance x₂ of the shaking table body, and an equation expression of the state observer is as follows:

$$[ \begin{matrix}{\dot{z}}_{1} \\ {\dot{z}}_{2}\end{matrix} ] = [ \begin{matrix}- {β}_{1} & 1 \\ - {β}_{2} & 0\end{matrix} ] [ \begin{matrix}{z}_{1} \\ {z}_{2}\end{matrix} ] + [ \begin{matrix}{b}_{0} \\ 0\end{matrix} ] u + [ \begin{matrix}{β}_{1} \\ {β}_{2}\end{matrix} ] y$$

$$\hat{y} = [ \begin{matrix}1 & 0\end{matrix} ] [ \begin{matrix}{z}_{1} \\ {z}_{2}\end{matrix} ]$$

where z₁ is an observed value of velocity x₁; ż₁ is a derivative of the observed value z₁ of the velocity x₁; z₂ is an observed value of the total disturbance x₂; ż₂ is a derivative of the observed value z₂ of the total disturbance x₂; ŷ is an observed value of an output velocity of the seismic simulation shaking table system; and β₁ and β₂ are gains of the state observer, which are related to convergence rates of the state observed values; and
where β₁ is the gain associated with z₁; β₂ is the gain associated with z₂, which can be determined by a linear observer design method according to a frequency bandwidth requirement, that is, all characteristic roots of a state matrix are configured to a same point −wₒ on a negative semi-axis of a real number axis, satisfying a first Lyapunov stability condition, and the observed values can converge to actual values.

An expression of the state error feedback control law is as follows:

$$u = \frac{{k}_{p} ( r - {z}_{1} ) + {k}_{i} ( r \frac{1}{2} - {d}_{1} ) + {k}_{d} rs - {z}_{2}}{{b}_{0}}$$

where kₚ, kᵢ and k_{d} are gains of the velocity signal, the displacement signal and the acceleration, r is a velocity signal output by the signal generator, d₁ is displacement signals in the 6-DOF directions of the shaking table body, z₁ is the observed value of the velocity x₁, z₂ is the observed value of the total disturbance x₂, b₀ represents the characteristic of the control object, and s is a complex variable that transforms a time domain function into a complex frequency domain through Laplace transformation.

In this example, each parameter of the disturbance rejection controller is determined according to a frequency bandwidth requirement of seismic wave recurrence. For example, an upper limit of an angular frequency of a frequency bandwidth of the seismic wave recurrence is m, in rad/s. A bandwidth of the disturbance rejection controller can be taken as w_{c}=1.3*m, and the bandwidth of the state observer can be taken by 4 times the bandwidth of the controller, that is wₒ=5.2*m. Further, parameters

$${β}_{1} = 2 * {w}_{o} and {β}_{2} = {w}_{o}^{2}$$

of a state observer matrix are calculated, b₀ is selected from large to small according to system stability, values of gains kₚ, kᵢ and k_{d} can be determined by designing closed-loop transfer function characteristics of the disturbance rejection controller, which generally take kₚ=2*0.707*w_{c},kᵢ=w_{c}2/4 and k_{d}=1.

By bringing the state error feedback control law into a first-order system expression, a closed-loop transfer function of the disturbance rejection controller is obtained:

$$\frac{y ( s )}{r ( s )} = \frac{{k}_{d} {s}^{2} + {k}_{p} s + {k}_{i}}{{s}^{2} + {k}_{p} s + {k}_{i}}$$

where kₚ, kᵢ and k_{d} are the gains of the velocity signal, the displacement signal, and the acceleration.

In this example, the parameters of the disturbance rejection controller are determined according to the frequency bandwidth requirement of the seismic wave recurrence. For example, the frequency bandwidth requirement of seismic wave recurrence is 0-25 Hz, the bandwidth of the disturbance rejection controller can be 1.3 times the frequency bandwidth, that is, 32.5 Hz, the angular frequency is expressed as w_{c}=32.5*2*π, and according to the closed-loop transfer function of the disturbance rejection controller, kₚ=2*0.707*w_{c}, kᵢ=w_{c}2/4 and k_{d}=1 can be taken. According to experience, the bandwidth of the disturbance rejection controller with 4 times of the observer bandwidth, that is wₒ=4*w_{c}, the parameters of the observer matrix are

$${β}_{1} = 2 * {w}_{o} and {β}_{2} = {w}_{o}^{2} ,$$

b₀ is selected from large to small according to the stability of the seismic simulation shaking table system, and in this case, b₀=800.

A transfer function of the notch filter is as follows:

$$N ( s ) = \frac{{s}^{2} + 2 * g * c * w * s + {w}^{2}}{{s}^{2} + 2 * c * w * s + {w}^{2}}$$

where W is a notch frequency in rad/s, g is a notch gain, and C is a damping ratio.

In this example, W is the notch frequency in rad/s, g is the notch gain, and C is the damping ratio. White noise is input and identified to obtain resonance peak frequencies, amplitudes, frequency bandwidths and other parameters of each component and the shaking table body in the seismic simulation shaking table system, and notch filter parameters are set according to these parameters. In this case, w=2*π*18, g=6 and c=0.01 are taken.

The total disturbance includes an external disturbance and an internal disturbance.

The external disturbance includes the coupling effect of waves and water currents, and the resonance effect among a test piece, each actuator and the shaking table body 1.

The internal disturbance includes a modeling error and an unmodeled portion of the seismic simulation shaking table system.

The velocity signals and the displacement signals in the 6-DOF directions of the shaking table body 1 are fed back into the disturbance rejection control loop, and the velocity signals in the 6-DOF directions of the shaking table body 1 are specifically as follows.

The actual acceleration signals in the 6-DOF directions of the shaking table body 1 are obtained by using the acceleration sensor 4, and Kalman filtering is performed to obtain the velocity signals in the 6-DOF directions of the shaking table body 1 by the velocity synthesis method.

The velocity signals in the 6-DOF directions of the shaking table body 1 are obtained by the velocity synthesis method, specifically as follows.

After the actual displacement signal of each actuator is low-pass filtered, the displacement signals in the 6-DOF directions of the shaking table body 1 are obtained by using the DOF synthesis matrix.

The displacement signals in the 6-DOF directions of the shaking table body 1 are differentiated and low-pass filtered, the actual acceleration signals in the 6-DOF directions of the shaking table body 1 are integrated and high-pass filtered, and the low-pass filtered after the two are summed to obtain the velocity signals in the 6-DOF directions of the shaking table body 1.

To sum up, the operation mechanism of the present disclosure for inputting the target seismic wave into the whole control system is as follows.

Acceleration signals of the target seismic wave in the 6-DOF directions are input into the control system, for each DOF, the actual acceleration signal of the shaking table body 1 is first fed back and corrected by the acceleration outer closed loop, and compensated for the resonance effect of the test piece through the notch filter. The signal generator processes the compensated acceleration signal to obtain the acceleration, velocity and displacement signals, and removes the low-frequency portion to prevent the influence of zero drift. Control quantities in the 6-DOF directions are obtained through state error feedback. The control quantities in the 6-DOF directions are decomposed into each actuator direction through the DOF decomposition matrix, and the movement of each actuator is controlled to drive the movement of the shaking table body 1. The displacement signal fed back by each actuator is processed by the DOF synthesis matrix to obtain the displacements of the table body in the 6-DOF directions. The signals from the acceleration sensor mounted on a table face of the shaking table body 1 are processed by Kalman filtering to obtain the accelerations of the table body in the 6-DOF directions. As shown in FIG. 4, the velocity synthesis method is used to perform low-pass filtering processing after displacement differential operation and high-pass filtering processing after acceleration integral operation. Cut-off frequencies of the two filtering are consistent, and low-pass filtering is performed after the two are summed to obtain the velocity signals in the 6-DOF directions for feedback.

The foregoing description of the disclosed examples enables those skilled in the art to implement or use the present disclosure. Various modifications to these examples will be apparent to those skilled in the art, and the general principles defined herein may be implemented in other examples without departing from the spirit or scope of the present disclosure. Therefore, the present disclosure is not intended to be limited to these examples shown herein but is to be accorded the widest scope consistent with the principles and novel features disclosed herein.

1. A control method for a seismic simulation shaking table under combined loading of seismic waves and currents, comprising the steps of:
establishing a seismic simulation shaking table system and a control system; and
taking a target seismic wave as a reference signal, taking an actual acceleration signal of a shaking table body (1) in the seismic simulation shaking table system as a feedback signal, and jointly inputting the two into the control system, wherein
the control system comprises a disturbance rejection control loop, a proportional-integral-derivative (PID) control loop and an acceleration outer closed loop;
the acceleration outer closed loop is used for comparing the reference signal of the shaking table body (1) with the feedback signal, and obtaining a corrected actual acceleration signal through error correction;
a correction strategy of the acceleration outer closed loop is as follows:
an actual acceleration signal of the shaking table body 1 after Kalman filtering is subtracted from twice the target seismic wave signal;
the disturbance rejection control loop is used for compensating and processing the corrected actual acceleration signal and velocity signals and displacement signals of the shaking table body (1) in six-degree-of-freedom (6-DOF) directions to generate control instructions in the 6-DOF directions;
the disturbance rejection control loop comprises a disturbance rejection controller;
the disturbance rejection controller comprises a notch filter, a signal generator and a state observer;
the notch filter is used for compensating the resonance effect of the shaking table body (1) at a specific frequency to obtain a compensated acceleration signal;
the signal generator is used for processing the compensated acceleration signal to obtain acceleration, velocity and displacement signals, and removing the low-frequency portion to prevent the influence of zero drift;
the state observer is used for observing the velocity signals in the 6-DOF directions of the shaking table body (1) and the total disturbance of the seismic simulation shaking table system to obtain a velocity observation value and a total disturbance observation value output by the seismic simulation shaking table system;
the disturbance rejection controller is used for designing a state error feedback control law by combining the acceleration, velocity and displacement signals obtained by the signal generator with the velocity observation value, the displacement signals in the 6-DOF directions of the shaking table body (1), and the total disturbance observation value; and
the PID control loop is used for converting the control instructions into control signals of each actuator in the seismic simulation shaking table system through a DOF decomposition matrix, thereby driving the shaking table body (1) to move in the 6-DOF directions through each actuator, and feeding back the velocity signals and the displacement signals in the 6-DOF directions of the shaking table body (1) into the disturbance rejection control loop.

2. The control method for a seismic simulation shaking table under combined loading of seismic waves and currents according to claim 1, wherein the seismic simulation shaking table system comprises a building foundation (5), a shaking table body (1), a plurality of transverse actuators (2), and a plurality of vertical actuators (3);
the building foundation (5) is used for providing a support platform for the shaking table body (1);
the shaking table body (1) is used for generating a seismic wave motion corresponding to the target seismic wave;
the plurality of transverse actuators (2) and the plurality of vertical actuators (3) are used for applying force and displacement to the shaking table body (1) to simulate seismic waves with different intensity and frequency characteristics;
the plurality of transverse actuators (2) and the plurality of vertical actuators (3) are arranged with displacement sensors, and the displacement sensors are used for measuring and feeding back an actual displacement signal of each actuator;
the shaking table body (1) is arranged with an acceleration sensor (4), which is used for measuring actual acceleration signals in the 6-DOF directions of the shaking table body (1); and
the shaking table body (1) is movably connected to the building foundation (5) through the plurality of transverse actuators (2) and the plurality of vertical actuators (3).

3. The control method for a seismic simulation shaking table under combined loading of seismic waves and currents according to claim 1, wherein a sampling time of the target seismic wave is 0.001 s, and a seismic wave in a frequency band of 0.1-25 Hz is extracted by fast Fourier transform/inverse fast Fourier transform (FFT/IFFT).

4. The control method for a seismic simulation shaking table under combined loading of seismic waves and currents according to claim 1, wherein a method for constructing the state observer is as follows:
for any DOF of the shaking table body (1), the seismic simulation shaking table system is described as a system comprising a total disturbance term, and an expanded state space equation of the seismic simulation shaking table system is as follows:
$$[ \begin{matrix}{\dot{x}}_{1} \\ {\dot{x}}_{2}\end{matrix} ] = [ \begin{matrix}0 & 1 \\ 0 & 0\end{matrix} ] [ \begin{matrix}{x}_{1} \\ {x}_{2}\end{matrix} ] + [ \begin{matrix}{b}_{0} \\ 0\end{matrix} ] u + [ \begin{matrix}0 \\ 1\end{matrix} ] {\dot{x}}_{2}$$
$$y = [ \begin{matrix}1 & 0\end{matrix} ] [ \begin{matrix}{x}_{1} \\ {x}_{2}\end{matrix} ]$$
where u is an input velocity of the seismic simulation shaking table system under this DOF; x₁ is a velocity of the shaking table body at this DOF; \dot{x}₁ is a derivative of the velocity x₁ of the shaking table body at this DOF; x₂ is a total disturbance of the seismic simulation shaking table system; \dot{x}₂ is a derivative of the total disturbance x₂ of the seismic simulation shaking table system; y is an output velocity of the seismic simulation shaking table system; and b₀ represents a characteristic of a control object;
the state observer is constructed by using the expanded state space equation to obtain observed values of the velocity x₁ and total disturbance x₂ of the shaking table body, and an equation expression of the state observer is as follows:
$$[ \begin{matrix}{\dot{z}}_{1} \\ {\dot{z}}_{2}\end{matrix} ] = [ \begin{matrix}- {β}_{1} & 1 \\ - {β}_{2} & 0\end{matrix} ] [ \begin{matrix}{z}_{1} \\ {z}_{2}\end{matrix} ] + [ \begin{matrix}{b}_{0} \\ 0\end{matrix} ] u + [ \begin{matrix}{β}_{1} \\ {β}_{2}\end{matrix} ] y$$
$$\hat{y} = [ \begin{matrix}1 & 0\end{matrix} ] [ \begin{matrix}{z}_{1} \\ {z}_{2}\end{matrix} ]$$
where z₁ is an observed value of velocity x₁; ż₁ is a derivative of the observed value z₁ of the velocity x₁; z₂ is an observed value of the total disturbance x₂; ż₂ is a derivative of the observed value z₂ of the total disturbance x₂; ŷ is an observed value of an output velocity of the seismic simulation shaking table system; and β₁ and β₂ are gains of the state observer.

5. The control method for a seismic simulation shaking table under combined loading of seismic waves and currents according to claim 4, wherein
an expression of the state error feedback control law is as follows: u=
$$\frac{{k}_{p} ( r - {z}_{1} ) + {k}_{i} ( r \frac{1}{2} - {d}_{1} ) + {k}_{d} rs - {z}_{2}}{{b}_{0}}$$
where kₚ, kᵢ and k_{d} are gains of the velocity signal, the displacement signal and the acceleration, r is a velocity signal output by the signal generator, d₁ is displacement signals in the 6-DOF directions of the shaking table body, z₁ is the observed value of the velocity x₁, z₂ is the observed value of the total disturbance x₂, b₀ represents the characteristic of the control object, and s is a complex variable that transforms a time domain function into a complex frequency domain through Laplace transformation;
by bringing the state error feedback control law into a first-order system expression, a closed-loop transfer function of the disturbance rejection controller is obtained:
$$\frac{y ( s )}{r ( s )} = \frac{{k}_{d} {s}^{2} + {k}_{p} s + {k}_{i}}{{s}^{2} + {k}_{p} s + {k}_{i}}$$
where kₚ, kᵢ and k_{d} are the gains of the velocity signal, the displacement signal, and the acceleration.

6. The control method for a seismic simulation shaking table under combined loading of seismic waves and currents according to claim 5, wherein a transfer function of the notch filter is as follows:
$$N ( s ) = \frac{{s}^{2} + 2 * g * c * w * s + {w}^{2}}{{s}^{2} + 2 * c * w * s + {w}^{2}}$$
where w is a notch frequency in rad/s, g is a notch gain, and c is a damping ratio.

7. The control method for a seismic simulation shaking table under combined loading of seismic waves and currents according to claim 5, wherein the total disturbance comprises an external disturbance and an internal disturbance;
the external disturbance comprises the coupling effect of waves and water currents, and the resonance effect among a test piece, each actuator and the shaking table body (1); and
the internal disturbance comprises a modeling error and an unmodeled portion of the seismic simulation shaking table system.

8. The control method for a seismic simulation shaking table under combined loading of seismic waves and currents according to claim 1, wherein the velocity signals and the displacement signals in the 6-DOF directions of the shaking table body are fed back into the disturbance rejection control loop, and the velocity signals in the 6-DOF directions of the shaking table body (1) are specifically as follows:
obtaining the actual acceleration signals in the 6-DOF directions of the shaking table body (1) by using the acceleration sensor (4), performing Kalman filtering, and obtaining the velocity signals in the 6-DOF directions of the shaking table body (1) by the velocity synthesis method;
the obtaining the velocity signals in the 6-DOF directions of the shaking table body (1) by the velocity synthesis method specifically comprises the steps of:
performing low-pass filtering on the actual displacement signal of each actuator, and obtaining the displacement signals in the 6-DOF directions of the shaking table body (1) by using the DOF synthesis matrix; and
differentiating and low-pass filtering the displacement signals in the 6-DOF directions of the shaking table body (1), integrating and high-pass filtering the actual acceleration signals in the 6-DOF directions of the shaking table body (1), and low-pass filtering after summing the two to obtain the velocity signals in the 6-DOF directions of the shaking table body (1).
